(19) United States
(12) Patent Application Publication
(10) Pub. No.: US 2006/0226701 A1
(43) Pub. Date: Oct. 12, 2006

(54) Electrically conductive hydraulic hose

(75) Inventors: Michael C. Gatz, Chillicothe, IL (US); Paul G. Casperson, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/094,522

(22) Filed: Mar. 31, 2005

(51) Int. Cl. B60L 1/00

(52) U.S. Cl. 307/9.1

(57) ABSTRACT

A hydraulic power system is provided, which may include a source component configured to generate an electrical current and a receiving component configured to receive the electrical current generated by the source component. The system may further include at least one hydraulic hose having one or more embedded electrically conductive members being configured to carry the electrical current between the source component and the receiving component.

### TECHNICAL FIELD

The present disclosure is directed to electrically conductive hydraulic hose and, more particularly, to electrically conductive hydraulic hose configured to carry control signals, communication signals, and/or electrical power.

### BACKGROUND

Hydraulic power systems are used by work machines to provide mechanical power for creating motion of mechanical components. For example, hydraulic power is used to drive hydraulic motors to create rotational motion, actuate hydraulic cylinders to operate a work implement, and create many other types of motion. In addition to hydraulic power, electrical current may also be transmitted to or from electrical componentry associated with such hydraulically actuated mechanical components or positioned within close proximity to the mechanical components. Electrical wires configured to carry this electrical current may be exposed to the external environment work machines and, therefore, may be susceptible to damage. It may be desirable to encase or otherwise protect such electrical wires from damage.

Certain types of work machines may be configured to operate interchangeable work implements. For example, an excavator may be configured for use with a variety of attachable, hydraulically operated work implements, such as buckets, grapples, shears, etc. Given the development of interchangeable work implements, communication between work machines and work implements has become increasingly desirable.

A work machine may be configured to operate somewhat differently for different work implements. Therefore, it may be desirable to configure the work machine to recognize what kind of work implement is presently attached to the work machine. Further, work implements may have individual identification, which may be used for a variety of reasons. Identification information may enable a work machine to recognize not only what kind of work implement is attached, but monitor the whereabouts of a particular work implement (e.g., for inventory purposes) and operational information, such as how many hours a particular work implement has been operated.

Such operational information may enable maintenance schedules to be followed for work implements. In addition, such operational information may facilitate business data acquisition. For example, billing and accounting for rental of work implements may be based on, among other things, the number of hours in operation of the work implement during the rental period.

Systems have been developed for communication between equipment that feature consolidation of electrical wires with hose. For example, U.S. Pat. No. 5,616,965, issued on Apr. 1, 1997 to Wolf et al. (the '965 patent), discloses hose having embedded electrical conductors for transferring control signals between system components.

While the system of the '965 patent may provide the benefits of consolidating electrical wires with hose, the hoses of the '965 patent are for pneumatics rather than hydraulics. Further, the system is not configured to conduct electrical power for operation of a system component via the embedded conductors.

The present disclosure is directed to solving one or more of the problems set forth above.

### SUMMARY OF THE INVENTION

In one aspect, the present disclosure is directed to a hydraulic power system. The system may include a source component configured to generate an electrical current and a receiving component configured to receive the electrical current generated by the source component. The system may further include at least one hydraulic hose having one or more embedded electrically conductive members being configured to carry the electrical current between the source component and the receiving component.

In another aspect, the present disclosure is directed to a work machine having a hydraulic power system. The work machine may include a frame, a power source attached to the frame, and a hydraulically operated component. The work machine may further include a hydraulic pump powered by the power source and configured to pump hydraulic fluid to the hydraulically operated component. In addition, the work machine may include at least one hydraulic hose configured to carry the hydraulic fluid from the hydraulic pump to the hydraulically operated component. Also, the work machine may include a source component attached to the frame and configured to generate an electrical current, as well as a receiving component associated with the hydraulically operated component and configured to receive the electrical current generated by the source component. The hydraulic hose may include one or more embedded electrically conductive members configured to carry the electrical current between the source component and the receiving component.

### BRIEF DESCRIPTION OF THE DRAWINGS

FIG. 1 is a diagrammatic illustration of a work machine having a hydraulic power system according to an exemplary disclosed embodiment.

FIG. 2A is a schematic representation of a hydraulic power system according to an exemplary disclosed embodiment.

FIG. 2B is a schematic representation of a hydraulic power system according to another exemplary disclosed embodiment.

FIG. 3 is an exploded view diagrammatic illustration of an electrically conductive hydraulic hose and fitting according to an exemplary disclosed embodiment.

### DETAILED DESCRIPTION

Reference will now be made in detail to the drawings. Wherever possible, the same reference numbers will be used throughout the drawings to refer to the same or like parts.

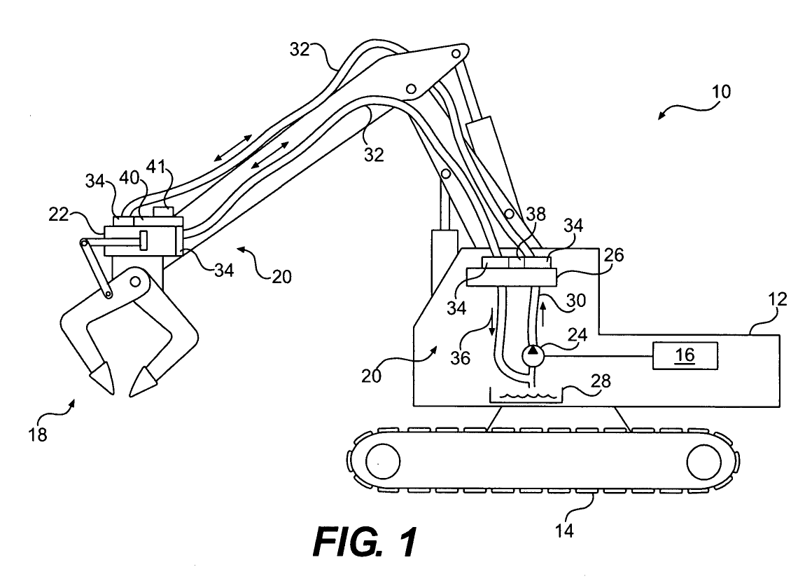

FIG. 1 illustrates a work machine 10. Work machine 10 may include a frame 12, traction devices 14 (only 1 shown), a power source 16, a hydraulically operated component, such as a work implement 18, and a hydraulic power system 20. Work machine 10, although shown in FIG. 1 as an excavator, may be any type of work machine having a hydraulic power system. Work machine 10 may be a mobile-type work machine, such as an excavator, track type tractor, loader, dump truck, or any other type of mobile work machine having a hydraulic power system. Further, work machine 10 may be a substantially stationary work machine, such as a crane, log splitter, etc.

Power source 16 may include an engine such as, for example, a diesel engine, a gasoline engine, a natural gas engine, a hydrogen engine, or any other engine apparent to one having ordinary skill in the art. Power source 16 may also include other sources of power such as a fuel cell, a power storage device, or any other source of power known in the art.

In view of the broad range of work machines to which the disclosed system is applicable, traction devices 14 may include tracks (as illustrated by FIG. 1), belts, wheels, tires, or any other device for moving a work machine.

Work machine 10 may include any type of hydraulically operated component. An exemplary hydraulically operated component is illustrated by work implement 18, as shown in FIG. 1. Although work implement 18 has been shown as a grapple in FIG. 1, work implement 18 may be any type of work implement. For example, work implement 18 may include a bucket, blade, grapple, jackhammer, shears, etc.

Hydraulic power system 20 may include, for example, a hydraulic actuator 22 (e.g., a hydraulic cylinder, as shown in FIG. 1) configured to operate work implement 18. Hydraulic actuator 22 may be actuated by hydraulic fluid pumped from a hydraulic pump 24 and regulated by a valve unit 26. Hydraulic pump 24 may draw hydraulic fluid from a reservoir 28, and pump the fluid along hydraulic line 30 to valve unit 26. Valve unit 26 may be controlled to determine which direction fluid may flow through one or more hydraulic circuits (i.e., flow may be reversible). For example, hydraulic fluid may flow in either direction in each of hydraulic lines 32. Fluid may flow in one direction to open the grapple, and in the opposite direction to close the grapple. Hydraulic lines.32 may be connected to actuator 22 and valve unit 26 with couplings 34 (e.g., hydraulic fittings). Return flow from hydraulic lines 32 may be routed upstream of hydraulic pump 24, as shown in FIG. 1 by an arrow 36, and/or return flow may be routed directly to reservoir 28.

Work machine 10 may further include a source component 38.

Source component 38 may be an electrical component configured to generate an electrical current. One or both of hydraulic lines 32 may be configured to conduct this electrical current to a receiving component 40 associated with work implement 18. Such association may include configurations varying in degree of association. For example, in some embodiments, receiving component 40 may be an integral part of work implement 18. In other embodiments, receiving component 40 may be attached to, but separate from, work implement 18. In yet other embodiments, receiving component 40 and work implement 18 may simply be in close proximity to one another.

Source component 38 and receiving component 40 may also be in opposite locations. That is, source component 38 may be associated with actuator 22 and receiving component 40 may be associated with valve unit 26. Further, multiple source components and/or multiple receiving components may be associated with any hydraulic component of system 20. In addition, actuator 22 and/or valve unit 26 may be associated with both source component 38 and receiving component 40. In such an embodiment, source component 38 and receiving component 40 may be incorporated into a single unit.

Work machine 10 may also include a memory device 41 associated with receiving component 40. Memory device 41 may be configured to store information transmitted from source component 38. Memory device 41 may be any type of suitable memory device or secondary storage device.

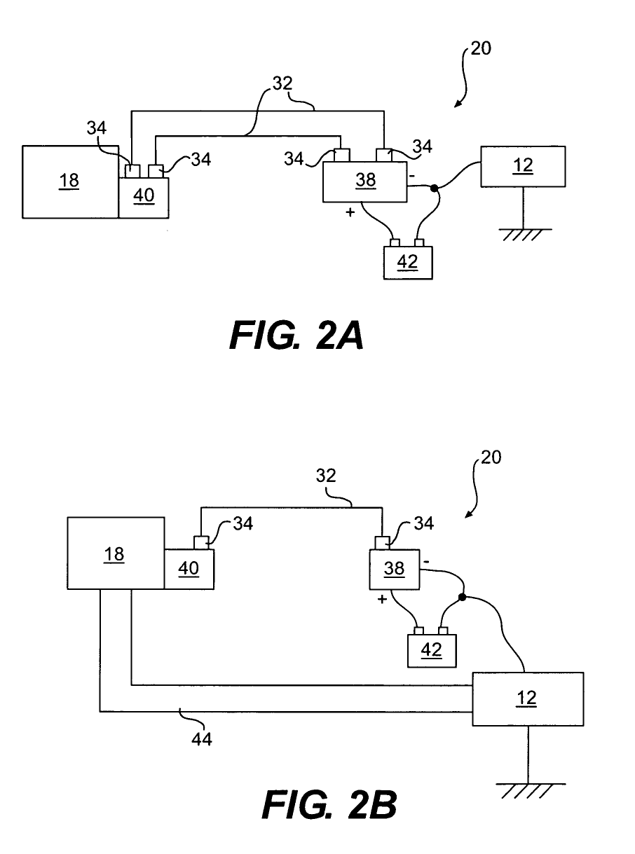

FIG. 2A illustrates an embodiment of system 20, which may be configured to deliver-electrical power (such as from a battery 42) from source component 38, along hydraulic lines 32, to receiving component 40 associated with work implement 18. Hydraulic lines 32 may be connected to source component 38 and receiving component 40 with couplings 34. System 20 may include more than one hydraulic line having an electrically conductive-element. With more than one conductive element, system 20 may be configured to both deliver and return electrical current over hydraulic lines 32. Electrical current may be conducted from source component 38 to receiving component 40 via one of hydraulic lines 32 and returned via the other of hydraulic lines 32 to be grounded. Work machine frame 12 may provide a further chassis ground.

FIG. 2B illustrates an embodiment of system 20, which may incorporate an electrically conductive hydraulic line 32 configured to deliver electrical current from source component 38 to receiving component 40 associated with work implement 18. However, in contrast to the embodiment shown in FIG. 2A, the embodiment of FIG. 2B utilizes a chassis ground exclusively to enable return flow of electrical current via an electrically conductive mechanical linkage 44 to an electrically conductive frame 12 of work machine 10. Although the chassis ground configurations shown in FIG. 2A and 2B illustrate delivery of electrical power, similar chassis ground configurations may be utilized for communication signals, as well.

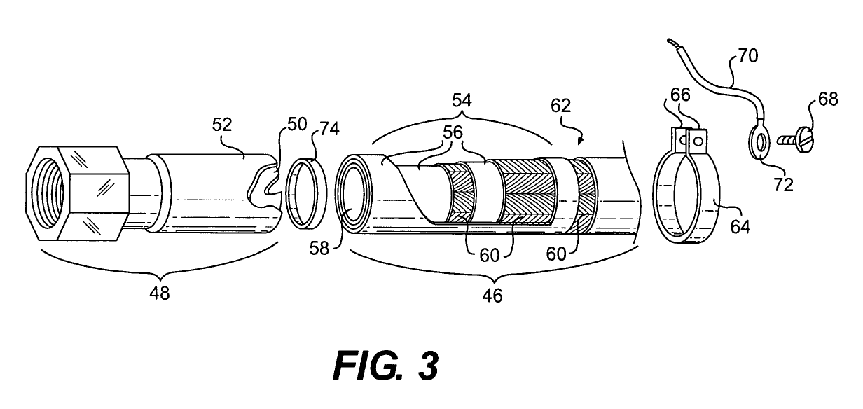

FIG. 3 illustrates an exploded view of a hydraulic hose 46.

Connection between hose 46 and other hydraulic components may be made with any type of suitable hydraulic coupling. For example, a threaded fitting 48 may be used, as shown in FIG. 3. Fitting 48 may include an inner male portion 50 and an outer collar 52. Fitting 48 may be attached to hose 46 by securing hose 46 between inner male portion 50 and outer collar 52. Fitting 48 may be secured onto hose 46 in any manner, for example, by crimping, threading, gluing, or any other suitable method.

Hose 46 may include multiple layers as illustrated by a cutaway portion 54. Hose 46 may include one or more electrically insulative layers 56.

Insulative layers 56 may be made from an insulative material, such as rubber or high strength textile. At least one of insulative layers 56 may be impervious to fluids. For example, at least an inner layer 58 may be made of rubber or any other material suited for such a purpose.

Embedded in hose 46, in or between insulative layers 56, may be one or more electrically conductive members 60. Electrically conductive members 60 may function solely to conduct electricity and, as such, may be simple in structure. For example, electrically conductive members 60 may be electrically conductive wires within the walls of hose 46. Electrically conductive members 60 may include more than one isolated conductor. Further, electrically conductive members 60 may have additional function, such as reinforcement of hose 46. For example, electrically conductive members 60 may include metal braiding embedded in or layered between insulative layers 56, as shown in FIG. 3.

Electrical connection may be made with one or more of electrically conductive members 60 in a variety of ways. In one embodiment, electrically conductive members 60 may be exposed by stripping away a portion of insulative layers 56 as shown at stripped area 62 in FIG. 3. Electrical connection may be made with a conductive contact ring 64, which may be attached to one or more electrically conductive members 60 in stripped area 62. Contact ring 64 may be clamped tightly against hose 46 with any suitable fixation means. For example contact ring 64 may include a pair of flanges 66 and a screw or bolt 68 may hold flanges 66 firmly together. An electrically conductive wire 70 may be attached to contact ring 64 to carry electrical current the rest of the way to receiving component 40.

Electrical connections between these elements may be made with any suitable electrically conductive coupling. Electrical connections can be made by compression through crimping, clamping, spring members, and any other type of compression mechanism. For example, wire 70 may-be attached to contact ring 64 with a blade, fork, or ring connector 72, which may be held tightly against contact ring 64 by bolt 68, as shown in FIG. 3. Alternatively or additionally, the electrical connections may be made metallurgically via soldering, brazing, or welding (e.g. spot welding or ultrasonic welding).

Wire 70 may carry electrical current to and/or from components of system 20. That is, while electrically conductive members 60 may carry electrical current along hose 46, a relatively shorter length of wire 70 may carry the current the rest of the way to a receiving component at a location within close proximity to contact ring 64. An insulative ring 74 may be utilized to insulate exposed electrically conductive members 60 at the end of hose 46 from contacting fitting 48.

In an alternative embodiment, rather than using contact ring 64 and wire 70, fitting 48 may be configured to conduct electrical current itself.

That is, fitting 48 may also serve as an electrical coupling through which electrical current may be transmitted.

### INDUSTRIAL APPLICABILITY

The disclosed electrically conductive hydraulic hose may be applicable to any hydraulic power system having electronic components separated by a length of hydraulic hose. In some embodiments these electronic components may be positioned at or near opposite ends of the hose. In other embodiments these electronic components may be separated by a length of hydraulic hose shorter than the full length of the hose. That is, electrical connection may be made to an embedded electrically conductive member at, for example, mid-hose, rather than at or near an end of the hose.

The disclosed hose may be applicable to hydraulic power systems of work machines. As discussed above, the disclosed hose may be applicable to any kind of work machine and may be configured to conduct any kind of electrical current. For example, the disclosed hose may be configured to conduct electrical power to and/or from one or more electrical components. Alternatively or additionally, the disclosed hose may be configured to conduct other types of electrical current. For example the disclosed hose may be configured to carry information signals, such as communication signals, control signals, data, or other types of information. Such information may include work implement identification, size, operating capabilities, operating instructions, location, maintenance information, rental information, user identification, and hours of operation.

The disclosed hose may enable this kind of communication between work machines and work implements. In addition to communication between work machines and work implements, electrical power may be supplied by the work machine to the work implement via the disclosed hose.

Such communication may enable a work machine to recognize what kind of work implement is presently attached to the work machine. Alternatively, or additionally, the work implement may be configured to recognize what kind of work machine it is attached to. Further, the work machine and/or the work implement may be configured to recognize the individual identification of each other. This identification, whether broad or specific, may be used for a variety of reasons. For example, identification information may enable a work machine to recognize not only what kind of work implement is attached, but monitor the whereabouts of a particular work implement (e.g., for inventory purposes). Operational information may also be transmitted, including, for example, hours in operation of the work implement or work machine.

The disclosed hose may be configured to carry control signals to various types of receiving components. For example, such control signals may include work implement movement command information.

An advantage of the disclosed hose may include ease of work machine assembly. For example, because electrically conductive members 60 may be integral with hydraulic hose 46, only the hose need be installed rather than both hose 46 and electrically conductive members 60 separately. Such consolidation may also lend itself to substantially quick and easy replacement of these components.

An additional advantage may include protection of electrically conductive members 60. Some work machines may be operated in environments that may be somewhat hazardous to external equipment on work machines. For example, forestry machines may be operated among tree branches and the like, which may become entangled in exposed work machine wires, possibly causing damage to the wires. Instead of using separate electrical wires as conductors, electrically conductive members may be embedded in hydraulic hose, which may be more durable than an electrical wire. Being embedded in hydraulic hose, electrically conductive members may be better protected from damage. Further, by consolidating the wires and hoses, the work machine may have less external equipment to become entangled.

It will be apparent to those having ordinary skill in the art that various modifications and variations can be made to the disclosed electrically conductive hydraulic hose without departing from the scope of the invention. Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A hydraulic power system, comprising:
a source component configured to generate an electrical current;
a receiving component configured to receive the electrical current generated by the source component; and
at least one hydraulic hose having one or more embedded electrically conductive members being configured to carry the electrical current between the source component and the receiving component.

2. The system of claim 1, wherein the electrical current includes a control signal.

3. The system of claim 2, further including a hydraulically operated component associated with at least one of the source component and the receiving component, the hydraulically operated component being responsive to the control signal.

4. The system of claim 3, wherein the hydraulically operated component includes a work implement.

5. The system of claim 4, wherein the control signal includes work implement movement command information.

6. The system of claim 1, wherein the electrical current includes a communications signal.

7. The system of claim 6, wherein the communications signal includes information about a hydraulically operated component with which at least one of the source component and the receiving component is associated.

8. The system of claim 7, wherein the hydraulically operated component includes a work implement and the information includes at least one of work implement identification, size, operating capabilities, operating instructions, location, maintenance information, rental information, user identification, and hours of operation.

9. The system of claim 1, wherein the electrical current includes electrical power to operate the receiving component.

10. The system of claim 1, wherein the one or more electrically conductive members includes more than one isolated electrical conductor, the system being configured to transmit the electrical current from the source component to the receiving component via one of the isolated electrical conductors and back to the source component via another of the isolated electrical conductors.

11. The system of claim 1, wherein the electrical current is delivered from the source component to the receiving component via the one or more embedded electrically conductive members in the at least one hydraulic hose and grounded via a chassis ground.

12. The system of claim 1, wherein the one or more embedded electrically conductive members includes reinforcement braiding within the at least one hydraulic hose.

13. The system of claim 1, wherein at least one of the source component and the receiving component is electrically connected to the at least one hydraulic hose by an electrical connection integral with a hydraulic hose fitting attached to an end of the at least one hydraulic hose.

14. The system of claim 1, wherein at least one of the source component and the receiving component is electrically connected to the at least one hydraulic hose by a contact ring in contact with the one or more embedded electrically conductive members.

15. The system of claim 1, wherein the receiving component is associated with a memory device configured to store information transmitted from the source component.

16. The system of claim 1, wherein each of a first end and a second end of the at least one hydraulic hose are associated with both a source component and a receiving component, the system being configured to transfer information from the first end to the second end and from the second end to the first end.

17. A work machine having a hydraulic power system, comprising:
a frame;
a power source attached to the frame;
a hydraulically operated component;
a hydraulic pump powered by the power source and configured to pump hydraulic fluid to the hydraulically operated component;
at least one hydraulic hose configured to carry the hydraulic fluid from the hydraulic pump to the hydraulically operated component;
a source component attached to the frame and configured to generate an electrical current; and
a receiving component associated with the hydraulically operated component and configured to receive the electrical current generated by the source component;
the hydraulic hose having one or more embedded electrically conductive members configured to carry the electrical current between the source component and the receiving component.

18. The work machine of claim 17, wherein the electrical current includes at least one of a control signal, a communications signal, and electrical power.

19. The work machine of claim 17, wherein the one or more electrically conductive members includes more than one isolated electrical conductor, the system being configured to transmit the electrical current from the source component to the receiving component via one of the isolated electrical conductors and back to the source component via another of the isolated electrical conductors.

20. The work machine of claim 17, wherein the electrical current is delivered from the source component to the receiving component via the one or more embedded electrically conductive members in the at least one hydraulic hose and grounded via a chassis ground.

21. The work machine of claim 17, wherein the one or more embedded electrically conductive members includes reinforcement braiding within the at least one hydraulic hose.
